(19) United States
(12) Patent Application Publication
(10) Pub. No.: US 2008/0122611 A1
(43) Pub. Date: May 29, 2008

(54) Field Control System and Wireless Communication Apparatus

(75) Inventors: Akira Nagashima, Tokyo (JP); Teruyoshi Minaki, Tokyo (JP); Satoru Kurosu, Tokyo (JP)

Correspondence Address: EDWARDS ANGELL PALMER & DODGE LLP, P.O. BOX 55874, BOSTON, MA, 02205, US

(73) Assignee: YOKOGAWA ELECTRIC CORPORATION, Tokyo (JP)

(21) Appl. No.: 11/658,936

(22) PCT Filed: Jul. 21, 2005
(86) PCT No.: PCT/JP05/13398

§ 371 Date: Jan. 29, 2007

(30) Foreign Application Priority Data
Jul. 27, 2004 (JP) 2004-218082

(51) Int. Cl. G08B 1/08

(52) U.S. Cl. 340/539.1

(57) ABSTRACT

A field control system includes: a field device installed in a process site; a control computer system connected to the field device via a signal line; and a wireless communication apparatus which is provided at a middle of the signal line, and includes a signal converting section for converting a signal being transmitted through the signal line based on a wireless protocol, and a wireless communication section for wirelessly transmitting the signal converted by the signal converting section, which are provided at a middle of the signal line.

### TECHNICAL FIELD

The present invention relates to a field control system and a wireless communication apparatus employed in this system, that improve a signal transmission/reception operation with a control computer system, etc., which is connected to field devices such as a pressure/differential pressure transmitter, various types of flowmeters, a thermometer and a valve positioner, that are distributed and arranged in a plant, a factory, etc.

### BACKGROUND ART

Field devices are distributed and arranged in a plant, a factory, etc. The field devices are a pressure/differential pressure transmitter, various types of flowmeters, a thermometer, a valve positioner, etc.

The field device is connected to a control computer system by a two-wire signal transmission line, etc., generates power from a signal of 4-20 mA being transmitted via the transmission line, and transmits collected data to the control computer system.

There is also a field device into which wireless means is incorporated, and such a field device transmits detected and collected data to the control computer system.

JP-T-10-508129, JP-A-2003-134030, JP-A-2003-134261, U.S. Pat. No. 5,682,476 and U.S. Pat. No. 6,236,334 are referred to as related arts.

FIG. 3 is a diagram showing an example of an overall of the system in which field devices serving as relate arts are connected. In FIG. 3, a valve V and a positioner P, a flowmeter F, and a differential pressure transmitter D including an orifice o are connected, as various types of field devices, to a pipe Q in which various types of fluids flow.

The individual field devices P, F and D are connected to a control system FCS via an input/output apparatus I/O by respective two-wire signal transmission lines L1, L2, L3. The individual field devices P, F and D are supplied with power by a signal of 4-20 mA, and transmit detected physical quantity signals (flow amount signals, pressure signals, etc.).

Further, a system has been proposed wherein the individual field devices P, F and D incorporate a wireless communication section, and convert detected physical quantity signals into radio signals so as to transmit the radio signals to a wireless station (not shown).

On the other hand, a system has been also proposed wherein in order to diagnose the individual field devices, a diagnosis tool MMI is installed at a higher level or a diagnosis sensor is provided for each of the existing field devices, and another signal line is newly installed in addition to the above two-wire signal transmission line for diagnosing the field devices.

The general configuration block of a field device is shown in FIG. 4.

In FIG. 4, a field device 10 has a sensor S that detects the physical quantity of each type of fluid, and includes: an A/D converter 11 which performs A/D conversion of a value from the sensor S; an operation section 12, such as a CPU, which performs various computation processes of the value from the A/D converter 11; a D/A converter 13 which performs a D/A conversion of the computation results from the operation section 12 and outputs the results to a two-wire signal transmission line L; and a receiving section 14 which receives various types of instruction signals, setting signals, etc., from the two-wire signal transmission line L and transmits them to the operation section 12.

It should be noted that the input/output apparatus I/O shown in FIG. 3 is actually a block shown in FIG. 4, that includes a power source B which supplies power to the two-wire transmission line L, a resistor R and an A/D converter (not shown).

With this arrangement, various computations are performed for the physical quantity detected by the sensor S, and the result is output as a 4-20 mA current signal to the two-wire transmission line L.

The input/output apparatus I/O receives this 4-20 mA current signal, and outputs the signal either to the control system (controller) FCS at a higher level or the diagnosis tool MMI.

### DISCLOSURE OF THE INVENTION

### Problems that the Invention is to Solve

However, when the wireless communication of the field device is discussed from a viewpoint of a diagnosis of the field device, redundancy of signal transmission, etc., it is troublesome to provide a wireless function to the existing field devices that are installed in a single system generally by multiple units. Further, it is also troublesome to adapt the circuit so as to add the wireless function one by one, and too much cost is required.

An objective of the present invention is to provide a field control apparatus and a wireless communication apparatus, that can easily make an existing field device be compatible to wireless.

### Means for Solving the Problems

The present invention provides a field control system, comprising:

a field device installed in a process site;

a control computer system connected to the field device via a signal line; and

a wireless communication apparatus which is provided at a middle of the signal line, and includes a signal converting section for converting a signal being transmitted through the signal line based on a wireless protocol, and a wireless communication section for wirelessly transmitting the signal converted by the signal converting section.

In the field control system, the wireless communication apparatus includes a power generating section for generating power from the signal being transmitted through the signal line.

In the field control system, the power generating section is a variable impedance.

In the field control system, the wireless communication section receives a radio signal.

In the field control system, the signal converting section converts the radio signal that is received by the wireless communication section, and

the wireless communication apparatus includes a wired communication section for superimposing the signal converted by the signal converting section onto a signal being transmitted through the signal line, and transmitting the signal to the field device.

In the field control system, the wireless communication apparatus includes a path setting section for determining a destination of the signal to be wirelessly transmitted from the wireless communication section.

In the field control system, the wireless communication apparatus includes a path setting section for determining a transmission destination of a signal to which the radio signal received by the wireless communication section is converted.

In the field control system, the wireless communication apparatus includes a battery as a power source.

In the field control system, the wireless communication apparatus is connected to the signal line in series.

In the field control system, the signal line is a two-wire transmission line.

The present invention provides a wireless communication apparatus that is provided at a middle of a signal line between a field device and a control computer system, the field device being installed in a process site and connected to the control computer system via the signal line, the wireless communication apparatus comprising:

a signal converting section for converting a signal being transmitted through the signal line based on a wireless protocol; and

a wireless communication section for wirelessly transmitting the signal converted by the signal converting section.

The wireless communication apparatus including:

a power generating section for generating power from the signal being transmitted through the signal line.

In the wireless communication apparatus, the power generating section is a variable impedance.

In the wireless communication apparatus, the wireless communication section receives a radio signal.

In the wireless communication apparatus, the signal converting section converts the radio signal that is received by the wireless communication section, and

the wireless communication apparatus includes a wired communication section for superimposing the signal converted by the signal converting section onto a signal being transmitted through the signal line, and transmitting the signal to the field device.

The wireless communication apparatus including:

a path setting section for determining a destination of the signal to be wirelessly transmitted from the wireless communication section.

The wireless communication apparatus including:

a path setting section for determining a transmission destination of a signal to which the radio signal received by the wireless communication section is converted.

The wireless communication apparatus includes a battery as a power source.

The wireless communication apparatus is connected to the signal line in series.

In the wireless communication apparatus, the signal line is a two-wire transmission line.

### Advantages of the Invention

According to the field control system and the wireless communication apparatus described above, since the signal converting section can convert the signal being transmitted through the signal line based on the wireless protocol and transmit the signal wirelessly, a diagnosis of the field device and the data processing can be easily performed.

Since the power for the wireless communication apparatus can be generated from the signal being transmitted through the signal line by a variable impedance, etc., saving in power can be realized.

Since the wireless communication apparatus can receive an external radio signal, bidirectional wireless communication is enabled.

Since the signal converting section converts the received radio signal, and the wired communication section superimposes the converted signal onto a signal to be transmitted through the signal line, various setups of the field device can be changed by wireless communication.

By the wireless path setting by the path setting section, the transmission destination of the radio signal corresponding to the signal being transmitted through the signal line or the transmission destination of an externally received radio signal can be set to not only the normal radio station, but also to the wireless communication apparatus that is connected to the other field device. Therefore, the wireless communication apparatus can be utilized as a radio relay point.

Since a battery is employed as a power source of the wireless communication apparatus, the consumption of power on the signal line is also prevented.

Since the wireless communication apparatus is connected in series to the signal line which is a two-wire signal transmission line, for example, a large revision or modification is not required for the field device and the signal line.

### BRIEF DESCRIPTION OF THE DRAWINGS

FIG. 1 A diagram showing an overall configuration of a field device according to the present invention.

FIG. 2 A diagram of an overall of a system that employs the field device according to the present invention.

FIG. 3 A diagram of an overall of a system that employs a field device as a related art.

FIG. 4 A configuration block diagram of a field device as a related art.

### DESCRIPTION OF REFERENCE NUMERALS AND SIGNS

10: field device
11: A/D converter
12: operation section
13: D/A converter
14: receiving section
S: sensor
20: wireless communication apparatus
21: variable impedance
22: signal converting section
22a: path setting section
23: wireless communication section
c1, c2: connecting point
B: power source
R: resistor
L, L1, L2, L3: two-wire signal transmission line

### BEST MODE FOR CARRYING OUT THE INVENTION

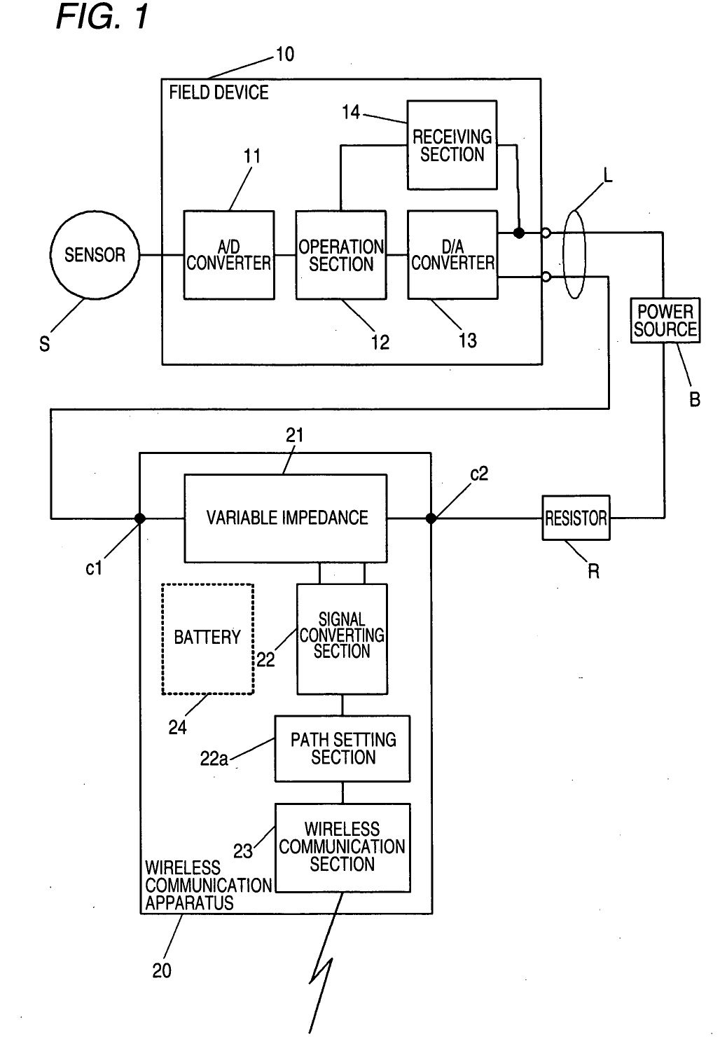

The present invention will now be described in detail while referring to drawings. FIG. 1 is a block diagram showing a configuration of a field device according to the present invention.

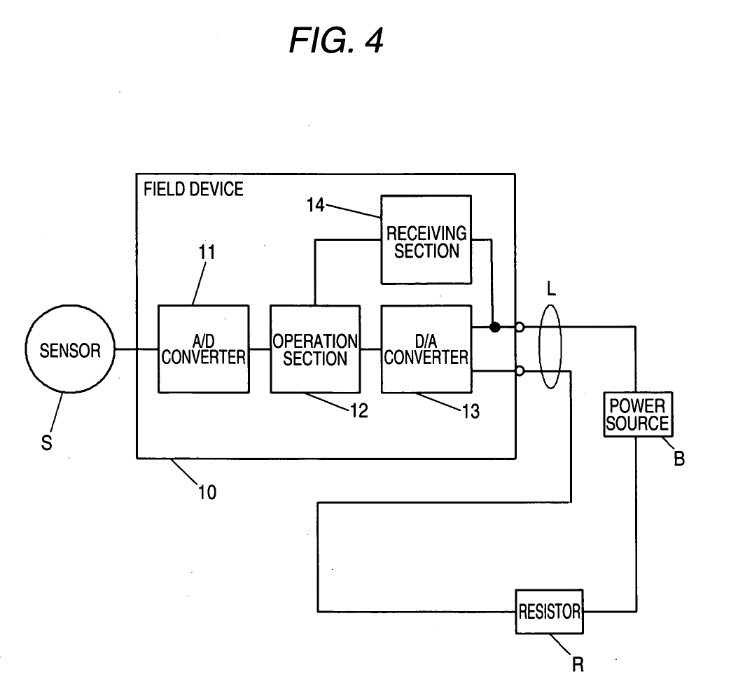

As shown in FIG. 1, a wireless communication apparatus 20 is connected in series to a two-wire signal transmission line L which connects a control computer system at a higher level and a field device 10, and is connected at a middle of the transmission line L. It should be noted that since the field device 10 has the same configuration as the field device 10 shown in FIG. 4, an explanation thereof is omitted.

This wireless communication apparatus 20 is installed so as to cut in at a middle of the two-wire signal transmission line L, that serves as communication means with the control computer system at a higher level and is provided to the existing field device 10.

This wireless communication apparatus 20 includes a variable impedance 21, a signal converting section 22, a wireless communication section 23 and a path setting section 22a.

The variable impedance 21 obtains power from a small amount of current that flows through the two-wire signal transmission line L. The signal converting section 22 converts a 4-20 mA current signal that flows through the transmission line L based on a wireless protocol. The wireless communication section 23 wirelessly transmits the signal converted by the signal converting section 22, and receives an external radio signal, or transfers the signal to another wireless communication apparatus 20, etc.

The signal converting section 22 converts the radio signal received by the wireless communication section 23. The variable impedance 21 connected to the signal line L modulates the signal converted by the signal converting section 22, and outputs the signal to the field device 10 side.

Further, the wireless communication apparatus 20 includes the path setting section 22a that, as will be described later, designates a wireless path for transmitting the radio signal to a radio station at a higher level mutually through wireless communication apparatuses that are installed for a plurality of field devices.

Specifically, the path setting section 22a is a circuit section in which an algorithm is set, such that the path setting section 22a designates a radio station at a higher level to be a transmission destination of the radio signal of the wireless communication apparatus 20, or designates, as a relay point, a wireless communication apparatus installed in the other field device, and further, when the wireless communication apparatus to be the relay point has a failure or abnormality, designates other field device.

It should be noted that instead of receiving power from the variable impedance 21 as a power source, a battery 24 may be installed in the wireless communication apparatus 20.

The present invention having this arrangement performs the following operation.

In order to perform the radio transmission of a signal received from the field device 10, the wireless communication apparatus 20 as shown in FIG. 1 is arranged in series at, for example, connecting points c1, c2, etc., on the two-wire signal transmission line L.

Then, first, from a 4-20 mA current that flows through the two-wire signal transmission line L, the variable impedance 21 generates the power required for the wireless communication apparatus 20, and supplies the power to the individual components of the wireless communication apparatus 20.

It should be noted that in the direct current area, the variable impedance is regarded as a general shunt regulator.

Sequentially, the signal converting section 22 converts a signal of 4-20 mA that flows through the two-signal transmission line L into a wireless protocol signal corresponding to the signal level, and transmits the signal to the wireless communication section 23. The wireless communication section 23 outputs this wireless protocol signal as a radio signal to a radio station at a higher level (not shown).

Or, by the variable impedance 21, a physical quantity signal from the field device 10 may be obtained as a digital signal by modulating the signal into a voltage or a frequency, and the signal is output as a radio signal.

In this manner, the radio signal corresponding to a magnitude of the current value of the signal that flows through the two-wire signal transmission line L can be externally output, and wireless communication can be performed between the field device 10 and an external radio station.

On the other hand, in a case where the wireless communication apparatus 20 is installed to the two-wire signal transmission line L and externally receives a radio signal indicating a setup change, etc., the following process is performed. This case corresponds to a replacement of a hand-held terminal for changing the setup of the field device 10, i.e., this case corresponds to a case where a setup change for the field device 10 is received wirelessly.

In this case, when a received radio signal is addressed to its own apparatus, the signal converting section 22 converts the radio signal into a voltage signal or a frequency signal, etc., and varies the impedance of the variable impedance 21. Thus, a setup signal, etc., included in the received radio signal is superimposed onto the two-wire transmission line L.

In this manner, when the wireless communication apparatus 20 is externally attached to the field device 10 which is connected to the two-wire signal transmission line L, the radio signal corresponding to the current signal that the field device 10 outputs to the two-wire signal transmission line L can be externally output.

Additionally, in a case where the radio signal for a setup, signal checking or monitoring from an external is received, this radio signal can be superimposed onto the two-wire signal transmission line L so that various setups for the field device 10 can be changed, or checking or monitoring of the field device can be performed.

Furthermore, since the path setting section 22a has a function for setting a destination to which the wireless communication apparatus 20 transmits a radio signal, and a destination to which the wireless communication apparatus 20 transfers a received radio signal, the following operation effects can be obtained.

In a case where a destination to which the wireless communication apparatus 20 transmits a radio signal suffers a failure, an abnormality, etc., a wireless path is set to change the destination to which the radio signal is transmitted, or to transfer the received radio signal to a wireless communication apparatus that is additionally provided to the other field device, simply as a relay point of the radio signal.

An example of generating the power for the wireless communication apparatus 20 from a current of 4-20 mA that flows through the two-wire signal transmission line L has been employed, however, the battery 24 may be internally arranged.

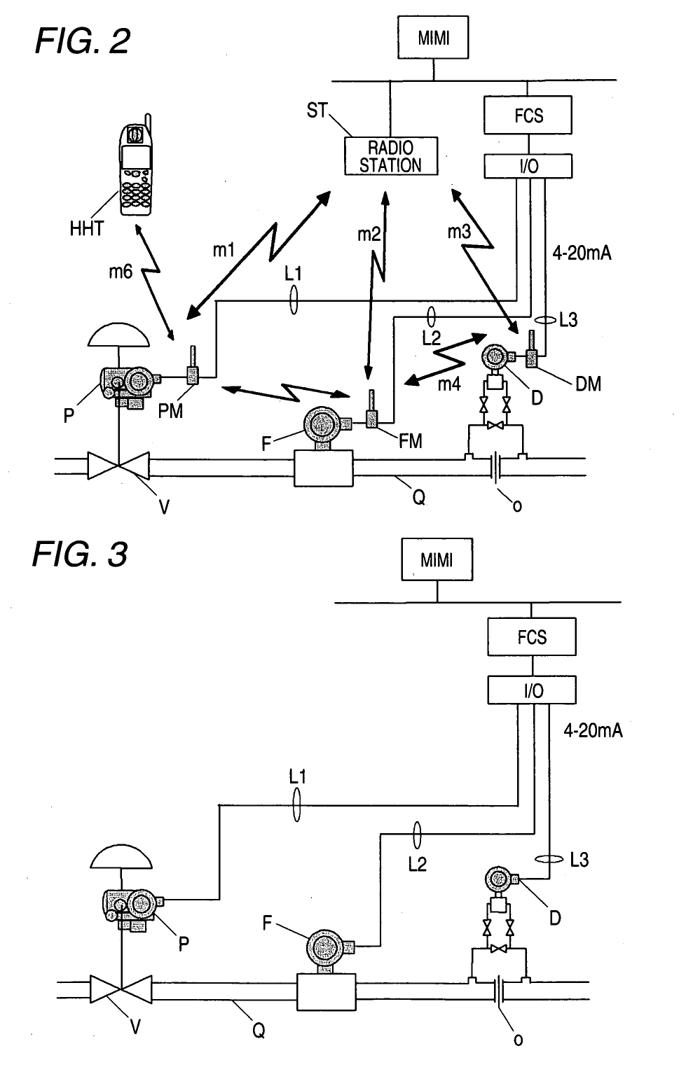

FIG. 2 shows an example of an overall of a system that includes field devices with wireless communication apparatuses 20 additionally provided. In this example, wireless communication apparatuses PM, FM, DM are additionally connected to two-wire signal transmission lines L1, L2, L3 to which field devices P, F, D, in the system shown in FIG. 3 are respectively connected.

As described above, these wireless communication apparatuses PM, FM, DM are respectively arranged at appropriate positions in the two-wire signal transmission lines L1, L2, L3.

With this arrangement, as radio signals m1, m2, m3, the individual field devices P, F, D can transmit signals to be transmitted to the two-wire signal transmission lines L1, L2, L3, to a radio station ST through the wireless communication apparatuses PM, FM, DM. Or, by using a radio signal m6, communication may be performed with a hand-held terminal HHT of a wireless system.

Further, since there is a case where a radio wave may not reach the radio station ST depending on the installation situations of the field devices P, F, D or the wireless communication apparatuses PM, FM, DM, a wireless path may be set, e.g., the radio signal m4 is transmitted from the wireless communication apparatus DM to the wireless communication apparatus FM; using the wireless communication apparatus FM as a relay point, the radio signal m5 is transmitted from the wireless communication apparatus FM to the wireless communication apparatus PM; and the radio signal m1 is transmitted from the wireless communication apparatus PM to the radio station ST.

Or, a path that is the opposite of the above described path may be set. Furthermore, when a wireless communication apparatus serving as a relay point suffers a failure, the wireless path may be altered to change the relay point.

Moreover, when the battery 24 is employed as a power generating section instead of generating the power from a current that flows through the signal transmission line L, power on the signal transmission line L is not consumed. Thus, a savings in power can be obtained.

In the above-described manner, wireless transmission and wireless reception of a signal related to the field device, and setup change by a radio signal, etc., associated with a field device can be performed.

The present invention is based on Japanese Patent Application (No. 2004-218082), filed on Jul. 27, 2004, and the contents thereof are incorporated herein as reference.

1. A field control system, comprising:
a field device installed in a process site;
a control computer system connected to the field device via a signal line; and
a wireless communication apparatus which is provided at a middle of the signal line, and includes a signal converting section for converting a signal being transmitted through the signal line based on a wireless protocol, and a wireless communication section for wirelessly transmitting the signal converted by the signal converting section.

2. The field control system according to claim 1, wherein the wireless communication apparatus includes a power generating section for generating power from the signal being transmitted through the signal line.

3. The field control system according to claim 2, wherein the power generating section is a variable impedance.

4. The field control system according to claim 1, wherein the wireless communication section receives a radio signal.

5. The field control system according to claim 4, wherein the signal converting section converts the radio signal that is received by the wireless communication section, and
the wireless communication apparatus includes a wired communication section for superimposing the signal converted by the signal converting section onto a signal being transmitted through the signal line, and transmitting the signal to the field device.

6. The field control system according to claim 1, wherein the wireless communication apparatus includes a path setting section for determining a destination of the signal to be wirelessly transmitted from the wireless communication section.

7. The field control system according to claim 4, wherein the wireless communication apparatus includes a path setting section for determining a transmission destination of a signal to which the radio signal received by the wireless communication section is converted.

8. The field control system according to claim 1, wherein the wireless communication apparatus includes a battery as a power source.

9. The field control system according to claim 1, wherein the wireless communication apparatus is connected to the signal line in series.

10. The field control system according to claim 1, wherein the signal line is a two-wire transmission line.

11. A wireless communication apparatus that is provided at a middle of a signal line between a field device and a control computer system, the field device being installed in a process site and connected to the control computer system via the signal line, the wireless communication apparatus comprising:
a signal converting section for converting a signal being transmitted through the signal line based on a wireless protocol; and
a wireless communication section for wirelessly transmitting the signal converted by the signal converting section.

12. The wireless communication apparatus according to claim 11, comprising:
a power generating section for generating power from the signal being transmitted through the signal line.

13. The wireless communication apparatus according to claim 12, wherein the power generating section is a variable impedance.

14. The wireless communication apparatus according to claim 11, wherein the wireless communication section receives a radio signal.

15. The wireless communication apparatus according to claim 14, wherein the signal converting section converts the radio signal that is received by the wireless communication section, and
the wireless communication apparatus includes a wired communication section for superimposing the signal converted by the signal converting section onto a signal being transmitted through the signal line, and transmitting the signal to the field device.

16. The wireless communication apparatus according to claim 11, comprising:
a path setting section for determining a destination of the signal to be wirelessly transmitted from the wireless communication section.

17. The wireless communication apparatus according to claim 14, comprising:
a path setting section for determining a transmission destination of a signal to which the radio signal received by the wireless communication section is converted.

18. The wireless communication apparatus according to claim 11, comprising:
a battery as a power source.

19. The wireless communication apparatus according to claim 11, wherein the wireless communication apparatus is connected to the signal line in series.

20. The wireless communication apparatus according to claim 11, wherein the signal line is a two-wire transmission line.
